(19) United States
(12) Patent Application Publication
(10) Pub. No.: US 2021/0237613 A1
(43) Pub. Date: Aug. 5, 2021

(54) BATTERY REGENERATION EFFICIENCY OPTIMIZATION

(71) Applicant: S2C, LLC, Albuquerque, NM (US)

(72) Inventors: Stephen Charles Cook, Albuquerque, NM (US); Stephen Jason Jenkins, Maple Valley, WA (US)

(21) Appl. No.: 16/778,530

(22) Filed: Jan. 31, 2020

(51) Int. Cl. B60L 58/12; B60L 50/61

(52) U.S. Cl. CPC B60L 58/12; B60L 50/61

(57) ABSTRACT

In a method for managing power storage and delivery in a hybrid vehicle, battery management program determines a battery charge state and identifies a charge variable affecting the battery charge state. The battery management program then retrieves data associated with the charge variable and identifies a preselected charge priority. Once the preselected charge priority is identified, the battery management program analyzes the retrieved data based on the identified charge priority and determines at least one charging parameter based in the analysis of the retrieved data.

### FIELD OF THE INVENTION

The field of the invention is battery management.

### BACKGROUND

With the increase in hybrid and electric vehicles, which rely solely and/or partially on electricity stored in batteries, battery management systems must recharge batteries before depletion. In order to ensure that batteries do not fully deplete, conventional battery management systems will recharge the battery each time the brake is depressed, thereby recharging the battery even when it is not close to depletion. Additionally, conventional battery systems in hybrid battery and combustion engine systems will not switch to a fully electric mode based on the battery charge level. Instead, conventional systems require a user to select whether the power is fully received from the battery.

As a result, conventional battery management systems for electric and hybrid vehicles can cause shortening of battery life cycles because they constantly recharge the battery even when sufficiently charged for the commute at hand. Conventional battery management systems for hybrid vehicles additionally lose fuel efficiency by failing to take advantage of only battery power when the conditions allow in order to avoid battery depletion. Thus, conventional battery management systems do not adequately maximize the charge cycles of a rechargeable battery and reduce unnecessary expenditure of resources, such as, for example, petroleum-based fuels.

U.S. Pat. No. 6,116,368 to Lyons teaches a method of managing energy transfer from regenerative braking to recharge a battery based on the amount of charge left in the battery. Lyons, however, discloses a method that simply recharges the battery based on the current charge state of the battery. As such, Lyons does not enable a battery management system to dynamically determine how much of the battery power can be depleted prior to being recharged based on multiple variables. Therefore, Lyons does not fully address the inefficiencies of conventional battery management systems for electric and hybrid vehicles because Lyons focuses on preventing overcharging rather than extending battery life and reducing consumption of alternative sources of power, including, for example, gasoline.

U.S. Pat. No. 6,856,866 to Nakao teaches a system apparatus for controlling hybrid vehicles where a control section has a full discharge mode without power assist. Nakao's computer system, however, simply designated either a full discharge mode or a non-full discharge mode. As such, the apparatus disclosed in Nakao is severely limited regarding battery management. For example, Nakao does not anticipate the use of variable charging and discharging based on recharge points, wherein the recharge points are determined by a variety of factors.

Lyons, Nakao, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for a system, a method, and an apparatus that allows dynamic and predictive management of energy regeneration in battery management systems based on multiple variables.

### SUMMARY OF THE INVENTION

A battery management system allows improved management of charging parameters by dynamically changing the charging parameters based on one or more charge variables associated with a charge objective.

Among other things, the inventive subject matter provides apparatus, systems, and methods in which a battery management program identifies a battery charge state and associated charge variables. The battery management program retrieves and analyzes data associated with a charge priority. After analyzing the data, the contemplated invention determines charging parameters based on the analysis.

Various resources, features, aspects and advantages of the inventive subject matter will become more apparent from the following detailed description of preferred embodiments, along with the accompanying drawing FIGURES in which like numerals represent like components.

### BRIEF DESCRIPTION OF THE DRAWINGS

FIG. 1 is a schematic of a method of determining a battery recharge point based on one or more variables and a charge priority.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including increasing battery life and fuel/energy efficiency.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

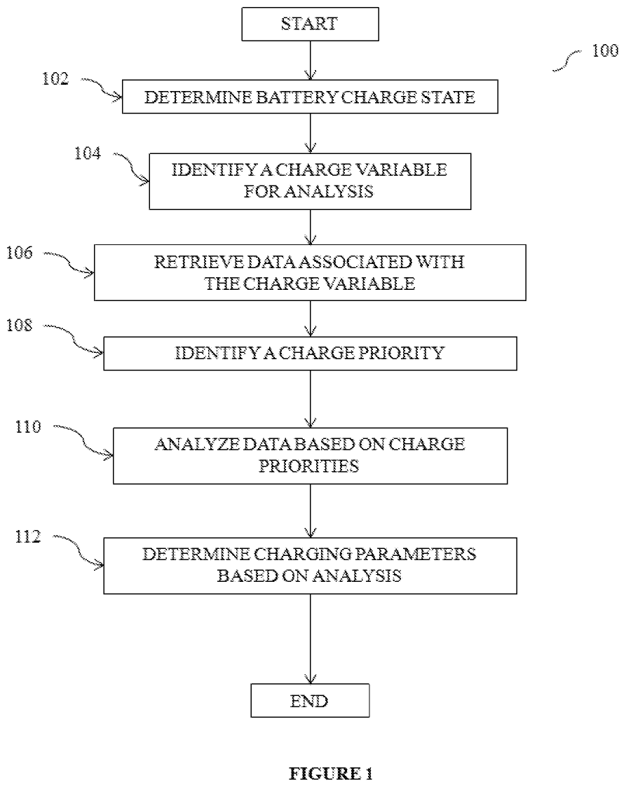

FIG. 1 is a schematic of a method of determining a battery recharge point based on one or more variables and a charge priority.

Battery management program 100 determines a battery charge state (step 102).

As used herein, a “battery” comprises any apparatus capable of capturing and storing energy. The present invention contemplates that the battery is capable of capturing and storing energy when the battery is in a depleted or semi-depleted state. However, it is also contemplated that the battery can be a one-time use battery in particular applications and apparatuses. For example, a one-time use battery can be used in an underwater drone made to explore an area with extremely low accessibility (e.g., the deep sea), record data, and transmit data without returning for a second use.

A battery charge state comprises the amount of charge in the left in the battery as well as any other information associated with state of the battery. For example, the battery charge state can include the amount of power left in the battery, the rate of recharging from regenerative braking, and idle energy consumption.

It is contemplated that the battery charge state can be measured in any way known in the art. For example, the battery charge state can be measured by voltage, using a hydrometer, coulomb counting, Kalman filtering, current integration, pressure, and/or impedance spectroscopy.

Battery management program 100 identifies a charge variable for analysis (step 104).

It is contemplated that charge variables can include any variable or combination of variables that directly or indirectly affect the battery charge state. Charge variables can be direct factors associated with the vehicle itself or external factors, including, for example, environmental variables and user-based variables.

Internal variables can comprise any factors associated directly with the vehicles and its constituent parts. For example, the weight, size, horsepower, battery capacity, battery charge rate, battery lifespan, and fuel efficiency.

It is contemplated that environmental variables can include variables such as the terrain, the length of commute, the inclines and decline in topology, the temperature, the time, and the weather.

In preferred embodiments, battery management program 100 identifies predicted variables based on the environmental variables. For example, battery management program 100 can identify the predicted temperature of a designated part of a commute by the route of the vehicle, the time of day the vehicle will be in the designated part, and the topology of the designated part.

It is contemplated that user-based variables are variables associated with how a user operates a vehicle and its effect on the battery charge state. For example, variables can include, but are not limited to, rate of acceleration, frequency of braking, and rate of speed reduction when braking. However, it is contemplated that user-based variables can be any variables associated with a user.

Battery management program 100 retrieves data associated with the charge variable (step 106).

It is contemplated that data associated with the charge variable can include any information or combination of information that directly or indirectly quantifies the effect of the charge variable on the battery charge state. For example, battery management program 100 can retrieve topology data for a portion of a commute that indicates an overall moderate incline when averaged.

In preferred embodiments, battery management program 100 retrieves data for multiple charge variables. For example, battery management program 100 can retrieve environmental data, including, for example, topology data, temperature data, and speed limit data for a selected portion of a commute.

In another example, battery management program 100 can retrieve data regarding user based variables, including, for example, average rate of acceleration, average speed of travel, average fuel economy, and average braking distance.

It is contemplated that battery management program 100 can retrieve data directly from physical data storage devices, such as hard drives, flash memory, and solid state drives. In other embodiments, battery management program 100 can retrieve data wirelessly, using any wireless communications medium known in the art. For example, battery management program 100 can retrieve data from a remote server over a cellular data signal. In another example, battery management program 100 can be connected over wireless fidelity (WIFI) based communications mediums to remote servers. In yet another example, battery management program 100 may be connected over a shorter range wireless connection, such as a connection to a Bluetooth-based device.

Internal variables can comprise any factors associated directly with the vehicles and its constituent parts. For example, the weight, size, horsepower, battery capacity, battery charge rate, battery lifespan, and fuel efficiency.

It is contemplated that environmental variables can include variables such as the terrain, the length of commute, the inclines and decline in topology, the temperature, the time, and the weather.

In preferred embodiments, battery management program 100 identifies predicted variables based on the environmental variables. For example, battery management program 100 can identify the predicted temperature of a designated part of a commute by the route of the vehicle, the time of day the vehicle will be in the designated part, and the topology of the designated part.

It is contemplated that user-based variables are variables associated with how a user operates a vehicle and its effect on the battery charge state. For example, variables can include, but are not limited to, rate of acceleration, frequency of braking, and rate of speed reduction when braking. However, it is contemplated that user-based variables can be any variables associated with a user.

Battery management program 100 identifies a charge priority (step 108).

Charge priorities can comprise any combination of factors that are prioritized over other. In some embodiments, charge priorities can comprise one or more ranked lists of priorities. In other embodiments, charge priorities can be a single priority. It is contemplated that battery management program 100 can change one or more charge priorities dynamically. For example, battery management program 100 can change a charge priority for a battery in response to changes environmental conditions (e.g., incline, decline, temperature, etc.).

Battery management program 100 can receive one or more charge priorities directly from a user. For example, in a situation where the route is significantly downhill, a user can set a charge priority that instructs battery management program 100 to allow the battery to expend as much energy as possible before recharging with regenerative braking. In this example, a user may advantageously change the charging characteristics of battery management program 100 to take advantage of environmental variables.

It is also contemplated that battery management program 100 can determines one or more charge priorities automatically based on changing charge variables in some embodiments.

For example, battery management program 100 can determine that the charge priority is to maximize recharging of the battery where the battery is at a sufficiently high risk of depletion. In another example, battery management program 100 can determine that the charge priority is to minimize damage to a battery where the environmental variables can cause permanent reduction in battery charge cycles.

Battery management program 100 analyzes data based on the charge priority (step 110).

It is contemplated that data can comprise any measurable and recordable metric associated with battery management. For example, the data can be associated with the user, the vehicle, the battery, the brakes, and any other component or measurable behavior associated with battery management.

It is contemplated that battery management program 100 analyzes data for one or more charge variables associated with the charge priority.

For example, battery management program 100 can analyze topology data, temperature data, and user behavioral data based on the charge priority of increasing fuel efficiency. In another example where the charge priority is to prevent overcharging, it is contemplated that battery management system 100 can analyze historical driving data (e.g., average power regeneration for a route, user-braking behavior, etc.), route data, and average power regeneration over the course of the route.

Battery management program 100 determines charging parameters based on the analysis (step 112).

Charging parameters can include anything associated with the manner in which the battery functions. For example, charging parameters can be one or more of a recharge rate, recharge point, a discharge rate, a power source, and a recharging schedule. However, charging parameters can include any rules that control how one or more charging variables are controlled.

In embodiments where battery management program 100 continuously analyzes data associated with the charge priority, it is contemplated that the charging parameters can change dynamically. Additionally, it is also contemplated that battery management system 100 can change variables associated with recharging dynamically, including, for example, the rate of recharge, the length of recharge, and the source of power (e.g., recharging from fuel and recharging from regenerative braking).

In a first example, battery management program 100 can determine that optimal charging of the battery will be achieved by regenerative braking at any time possible where a selected route is substantially uphill and the ambient temperature along the route allows for short and intense periods of charging with minimal damage to the battery.

In another example, battery management program 100 can determine that below freezing temperatures along the route will reduce battery life. In response, battery management program 100 can subsequently adjust a recharge point to activate recharging when the battery is at 20% of capacity rather than at 10% capacity in order to minimize the risk of battery depletion. In addition to changing the recharge point, battery management program 100 can determine the capacity of the battery at below freezing temperatures and adjust the recharge point relative to the determined capacity of the battery.

### Example 1

A user drives a hybrid vehicle capable of being powered by battery alone, fuel alone, or a combination of both. Additionally, the battery can be charged by the combustion engine and regenerative braking.

During a weekday commute, battery management program 100 determines that the battery charge state is at 20% of its full capacity. Battery management program 100 identifies the charge variables of temperature, topology, and route associated with the battery. In response to identifying the available charge variables for the situation, battery management program 100 retrieves historical data stored within the past year and current data for each of the charge variables. Based on the low amount of remaining charge, battery management program 100 determines that the charge priority is to maximize fuel economy.

In order to determine how to maximize the fuel economy, battery management program 100 analyzes the temperature data, the topology data, route data, and the user braking behavior data. Overall, the temperature data indicates temperatures with a normal range of battery operating temperatures, the topology data indicates steep declines for the next seven miles and steep inclines for the remaining seven miles to the destination, and the route data historically indicates minimal traffic during commuting hours.

Based on the analysis, battery management program 100 determines that setting the battery to fully power the vehicle during the seven mile decline will still allow the battery to be charged to 80% given the power stored from regenerative braking. Battery management program 100 also determines that using 50% battery power and 50% combustion-based power (which partially recharges the battery) on the seven mile incline will leave the battery with 20% of its full capacity at the destination. Battery management program 100 determines that leaving 20% charge on the battery at the destination will minimize overall fuel consumption.

Additionally, battery management program 100 determines that leaving 20% charge on the battery at the destination is not problematic, given that power provided by regenerative braking for the first seven miles of the reverse route can be used to recharge the battery.

Battery management program 100 then causes the battery to be managed according to the determined charging parameters.

Unlike the presently described battery management program, conventional battery management systems do not take into consideration complex environmental and user-based factors in determining how to manage a battery. Additionally, conventional systems do not contemplate dynamically changing battery management protocols in response to changing situational factors and associated charge priorities.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for managing power storage and delivery for a battery subject to at least one variable, comprising:
determining a battery charge state;
identifying a charge variable affecting the battery charge state;
retrieving data associated with the charge variable;
identifying a charge priority, wherein the charge priority is preset;
analyzing the retrieved data based on the identified charge priority; and
determining at least one charging parameter based in the analysis of the retrieved data, wherein the at least one charging parameter controls how the battery stores power.

2. The method of claim 1, wherein the charge variable comprises at least one of an internal factor or an external factor, wherein the internal factor is directly affects the battery and the external factor indirectly affects the battery.

3. The method of claim 1, wherein the charge priority comprises one or more battery management objectives.

4. The method of claim 1, further comprising changing the at least one charging parameter in response to a change in the charge priority.
